(19) United States
(12) Patent Application Publication
(10) Pub. No.: US 2011/0235592 A1
(43) Pub. Date: Sep. 29, 2011

(54) NETWORK RESOURCE LEASING

(75) Inventors: Guilherme Luiz Karnas Hoefel, San Diego, CA (US); Kirk Steven Taylor, San Diego, CA (US); Liren Chen, San Diego, CA (US)

(73) Assignee: QUALCOMM Incorporated, San Diego, CA (US)

(21) Appl. No.: 12/732,472

(22) Filed: Mar. 26, 2010

(51) Int. Cl. H04W 72/04

(52) U.S. Cl. 370/329

(57) ABSTRACT

Techniques for allowing network terminals to lease resources from one another. In an exemplary embodiment, an owner terminal determines the availability of resources (locally available or remotely accessible) to share with other terminals. The owner terminal establishes service and price level terms for sharing its resource, and advertises those terms to other terminals. A user terminal determines its own resource requirements, and searches a network for one or more owner terminals offering the desired resource. An owner terminal and a user terminal negotiate on the terms for use of an identified resource, and the owner terminal leases the resource to the user terminal. Applications include a virtual data center for leasing file storage space, network traffic bandwidth leasing to devices such as mobile phones, ad hoc distributed computing architectures, and third-party operating system (OS) support schemes.

### TECHNICAL FIELD

The disclosure relates to techniques for network resource sharing, and in particular, to techniques for leasing resources from one terminal on a network to another.

### BACKGROUND

Communications networks are becoming increasingly ubiquitous, with the advent of sophisticated wireline and wireless technologies for providing fast data communications between terminals. Examples of such networks include personal area networks enabled by USB or Bluetooth, local area networks enabled by Ethernet or IEEE 802.11, and wide area networks including the Internet. Terminals on a network are commonly configured to share information and data with one another.

In some cases, resources such as Internet access bandwidth, computational bandwidth, and other terminal-specific capabilities may also be shared between terminals over a network. However, dynamic allocation and sharing of resources presents certain challenges. As resources are scarce, the owner of a resource (or the “owner terminal”) must typically grant access to its local resources only on a limited basis, to avoid disrupting the owner terminal's internal operations. And since terminals on a network may often be owned and controlled by separate entities, owner terminals may preclude resource sharing altogether, as there is no perceived benefit to a terminal from sharing its resources with other terminals. This arrangement is inefficient, however, as there may be a substantial amount of idle resources sitting on a network that may be advantageously utilized by other terminals.

It would be desirable to provide a scheme whereby owner terminals may be induced to advertise and share their local resources with other terminals (or “user terminals”) for a benefit, and whereby user terminals may identify and convey payment to owner terminals for use of such resources.

### SUMMARY

An aspect of the present disclosure provides an apparatus comprising: a processor; and at least one memory coupled to the processor, the at least one memory storing instructions for causing the processor to implement an application module configured to run an application and a user broker module configured to: determine a requirement set of the application module; identify at least one remote terminal having a resource to at least partially satisfy the requirement set of the application module; enable the application module to use the resource of the at least one remote terminal according to a service agreement; and arrange for the at least one remote terminal to be compensated based on the use of the resource.

Another aspect of the present disclosure provides an apparatus comprising: a processor; and at least one memory coupled to the processor, the at least one memory storing instructions for causing the processor to implement a lease broker module configured to: determine terms on which a resource is available to be used by at least one remote terminal; advertise the terms to the at least one remote terminal; negotiate a service agreement with the at least one remote terminal to use the resource; enable the at least one remote terminal to use the resource; and arrange to be compensated by the at least one remote terminal based on the use of the resource.

Yet another aspect of the present disclosure provides a method comprising: determining a requirement set of an application module; identifying at least one remote terminal having a resource to at least partially satisfy the requirement set of the application module; enabling the application module to use the resource of the at least one remote terminal according to a service agreement; and arranging for the at least one remote terminal to be compensated based on the use of the resource.

Yet another aspect of the present disclosure provides a method comprising: determining terms on which a resource is available to be used by at least one remote terminal; advertising the terms to the at least one remote terminal; negotiating a service agreement with the at least one remote terminal to use the resource; enabling the at least one remote terminal to use the resource; and arranging to be compensated by the at least one remote terminal based on the use of the resource.

### BRIEF DESCRIPTION OF DRAWINGS

FIG. 1 illustrates an exemplary embodiment of a system operating according to the principles of the present disclosure.

FIG. 2 illustrates an exemplary embodiment of a system for leasing network resources according to the present disclosure.

FIG. 3 illustrates an exemplary embodiment of a procedure performed by the lease broker at the owner terminal shown in FIG. 2.

FIG. 4 illustrates an exemplary embodiment of a procedure performed by the user broker at the user terminal shown in FIG. 2.

FIG. 5 illustrates an exemplary embodiment of an interaction between the lease broker and the user broker during the bidding process.

FIG. 6 illustrates an exemplary embodiment of specific operations that may be performed by a lease broker during the bid negotiation blocks and the resource usage blocks shown in FIG. 5.

FIG. 7 illustrates an alternative exemplary embodiment of post-payment scheme that may be performed by the lease broker and the user broker to lease the resources of the owner terminal.

FIG. 8 illustrates an exemplary embodiment of a system wherein an arbiter is provided.

FIG. 9 illustrates an exemplary embodiment of a virtual data center according to the present disclosure.

FIG. 10 illustrates an exemplary embodiment of a network traffic bandwidth leasing scheme according to the present disclosure.

FIG. 11 illustrates an exemplary embodiment of a distributed computing scheme according to the present disclosure.

FIG. 12 illustrates an exemplary embodiment of an application/OS leasing scheme according to the present disclosure.

FIG. 13 illustrates an exemplary embodiment of an apparatus 250 for implementing either the owner terminal 210 or user terminal 220 described in FIG. 2.

### DETAILED DESCRIPTION

The detailed description set forth below in connection with the appended drawings is intended as a description of exemplary embodiments of the present invention and is not intended to represent the only exemplary embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

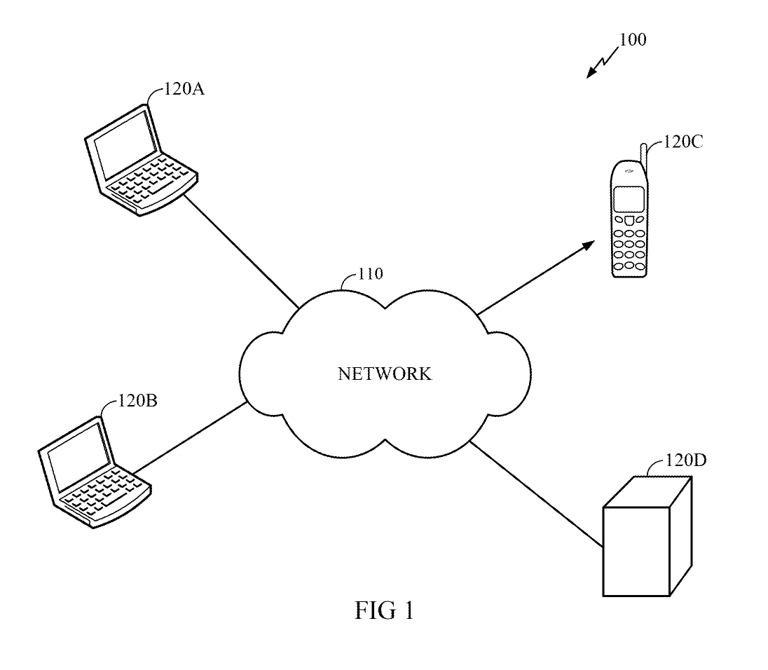

FIG. 1 illustrates an exemplary embodiment 100 of a system operating according to the principles of the present disclosure. Note the system 100 is shown for illustrative purposes only, and is not meant to limit the scope of the present disclosure to any particular number or types of terminals shown.

In FIG. 1, multiple terminals 120A, 120B, 120C, 120D are shown connected to a network 110. The terminals include personal computers 120A, 120B, a mobile phone 120C, and a mainframe computer 120D. The network 110 provides a communications platform over which the various terminals 120 can communicate with each other, and with other terminals (not shown) connected to the network. In an exemplary embodiment, the network 110 may be the Internet, and information transfer from terminal to terminal may be accomplished using, e.g., TCP/IP. Alternatively, the network 110 may be a Bluetooth network, an Ethernet-based local area network (LAN), etc. Terminals may be connected to the network 110 using any network connectivity technologies known in the art, and may include, e.g., wired connections such as Ethernet networking or modem connections, and/or wireless connections such as supported by wireless standards such as W-CDMA, cdma2000, Bluetooth, etc.

While the network 110 is shown as being interposed between any two terminals in FIG. 1, it will be appreciated that in alternative exemplary embodiments, any two terminals may also communicate directly with each other without necessarily traversing a “network.” For example, two terminals may communicate wirelessly with each other using Bluetooth, or any other type of direct wired or wireless connection, and such two terminals may also implement the resource leasing techniques of the present disclosure. Such alternative exemplary embodiments are contemplated to be within the scope of the present disclosure.

It will be appreciated that each of the terminals 120A, 120B, 120C, 120D typically possesses a certain amount of available local resources for performing its computational and/or processing tasks. For example, the personal computer 120A may process data using one or more CPU's locally provided within the personal computer 120A. Or, the personal computer 120B may store data using a local hard disk storage medium provided within the personal computer 120B. As a further example, the mobile phone 120C may perform, e.g., compression or decompression of video, using one or more processing engines located locally within the mobile phone 120C. In such applications, the processing and storage capability of each terminal is typically limited by the amount of local resources available at the terminal.

In some applications, it may be advantageous for a terminal to have access to additional processing or storage capability beyond what is locally available at the terminal. For example, while running a computationally intensive application, personal computer 120A (the “user terminal”) may exhaust its own computational resources, while personal computer 120B (the “owner terminal”), which is idle, may have the additional computational resources needed by personal computer 120A. While schemes for sharing resources between terminals are known in the art, such sharing is often impractical due to the lack of a general and flexible scheme for identifying available resources to be shared, as well as a system for equitably partitioning the resource usage amongst the different terminals. In the previous example, personal computer 120A may benefit from the use of the computational resources of personal computer 120B, yet personal computer 120A does not know that personal computer 120B has those resources, as personal computer 120B does not advertise its available resources. Furthermore, even if personal computer 120A did know of the availability of personal computer 120B's resources, personal computer 120B may not be willing to lend its resources to personal computer 120A, as the two computers may be owned by two unrelated entities, and thus there is no perceived benefit to the owner of computer 120B from lending its resources to computer 120A.

It would be desirable to provide flexible and universal techniques whereby owner terminals may be induced to advertise and share their local resources with user terminals for a benefit, and whereby user terminals may identify and convey payment to owner terminals for use, or “lease,” of their resources.

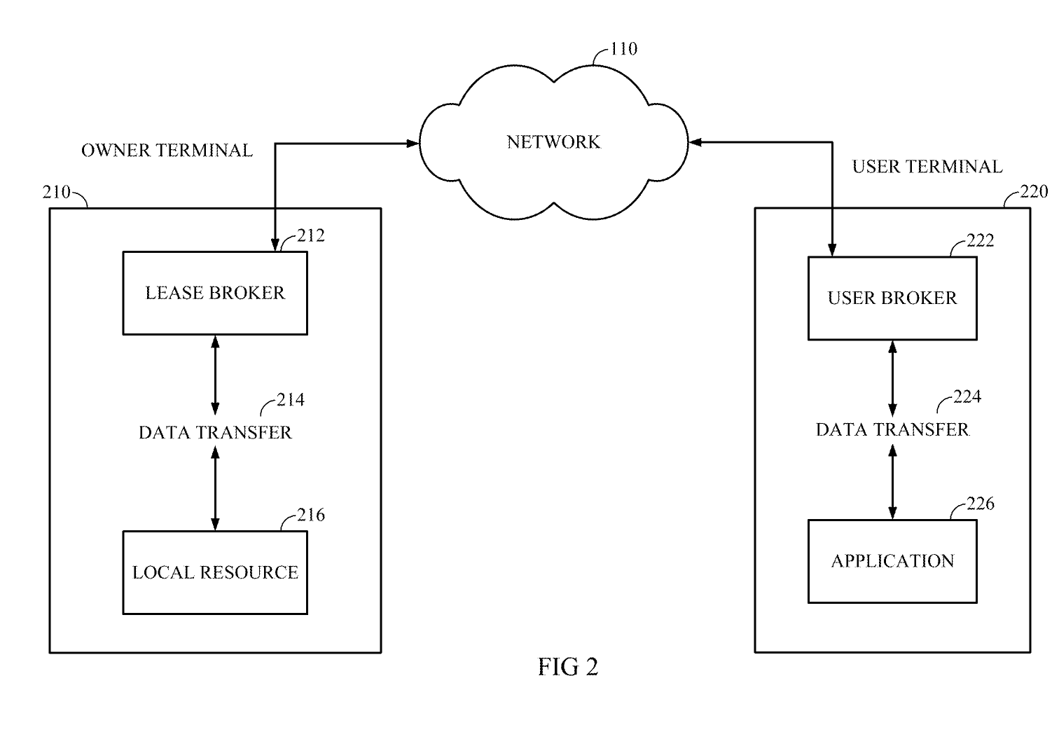

FIG. 2 illustrates an exemplary embodiment 200 of a system for leasing network resources according to the present disclosure. In FIG. 2, an owner terminal 210 communicates with a user terminal 220 via the network 110 to lease resources of the owner terminal 210 to the user terminal 220.

In FIG. 2, the owner terminal 210 owns a local resource 216 that is available to be shared with other users on the network 110. A lease broker 212 exchanges data 214 with the local resource 216, and also communicates with other terminals on the network 110. The lease broker 212 is responsible for determining parameters associated with the local resource 216 to be shared, such as the type of resource, the amount of the resource to be shared, and a time schedule according to which the resource may be shared. Such a time schedule may specify, e.g., a start time and a stop time over which the resource is available.

For example, in an exemplary embodiment wherein the local resource 216 is CPU processing capability, the broker 212 may determine, e.g., that 2 MIPS (or million instructions per second) of the local resource 216 is available for lease starting from a start time up to a stop time. The lease broker 212 may advertise these parameters to other terminals on the network 110, and negotiate terms under which the local resource 216 may be leased to other terminals.

According to the present disclosure, the local resource 216 may include, but is not limited to, CPU capacity, storage capacity, Internet bandwidth, electrical power, etc. Note these examples are given for illustrative purposes only, and it is contemplated that any resource that can be shared with other users is within the scope of the present disclosure.

In FIG. 2, at the user terminal 220, a local application 226 is being executed. The application 226 may request to use additional resources beyond what is locally available at user terminal 220. The application 226 communicates its additional resource requirements to a user broker 222 via data transfer 224. The user broker 222 is responsible for determining parameters associated with the resource requirements of the application 226, identifying potential owner terminals on the network 110 having leasable resources, and negotiating acceptable terms under which the user terminal 220 may lease resources from the owner terminal or terminals, e.g., the local resources 216 from the owner terminal 210.

As compensation for the lease of its local resource 216, the lease broker 212 may require payment. According to the present disclosure, such payment may include, but is not limited to, monetary currency, resource exchange, redeemable credits, etc. Note these examples of payment are given for illustrative purposes only, and it is contemplated that any form of value exchange is within the scope of the present disclosure.

Note in FIG. 2, while the resource 216 is shown as being locally available at the same device 210 on which the lease broker 212 is available (i.e., the resource 216 is a “local resource”), the resource 216 and lease broker 212 generally need not be located on a single device. For example, the lease broker 212 may be implemented on another device (not shown) separate from the device 210, and may handle the leasing of the resource 216 for the device 210 remotely, e.g., over the network 110. Such alternative exemplary embodiments are contemplated to be within the scope of the present disclosure.

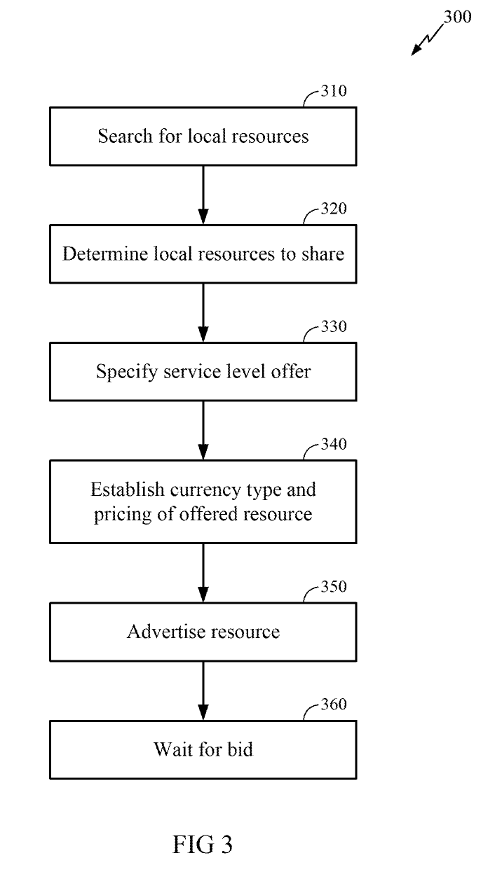

FIG. 3 illustrates an exemplary embodiment 300 of a procedure performed by the lease broker 212 at the owner terminal 210 shown in FIG. 2. Note FIG. 3 is shown for illustrative purposes only, and is not meant to limit the scope of the present disclosure to any particular procedure shown.

In FIG. 3, at block 310, the lease broker 212 searches for resources available at the owner terminal 210. In an exemplary embodiment, the lease broker 212 may be configured to access a list of pre-identified resources at the owner terminal 210, and may query a software or hardware controller at the owner terminal 210 to determine whether such resources are currently available for lease. Such resources may include, e.g., available CPU computational bandwidth, network traffic bandwidth, data storage, etc., as previously mentioned.

At block 320, the lease broker 212 may identify whether the locally available resources may be shared with other terminals on the network with minimal impact to the local terminal 210. For example, even if the owner terminal 210 has data storage resources locally available as determined at block 310, sharing of the owner terminal's data storage resources may not be appropriate at the moment if, e.g., the owner terminal 210 is a mobile device running low on battery power.

At block 330, the lease broker 212 establishes the service level that can be offered. Service level parameters may include types of resources, amounts of resources that may be leased, etc. For example, the owner terminal 210 may determine that given its available resources, it may serve as a traffic router, supporting up to 100 kilobits per second (kbps) of network traffic according to a certain time schedule. The owner terminal 210 may also determine that it may simultaneously serve as a computing node for a distributed architecture, supporting up to 2 MIPS of processing during a particular scheduled time. The service level parameters may further specify such parameters as availability, priority, etc.

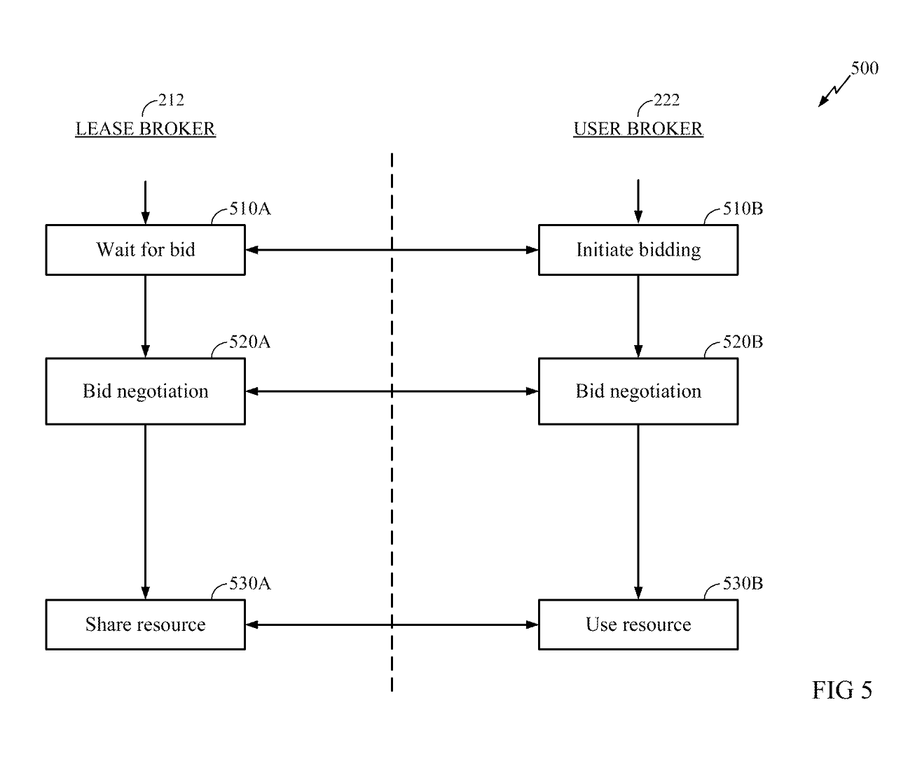

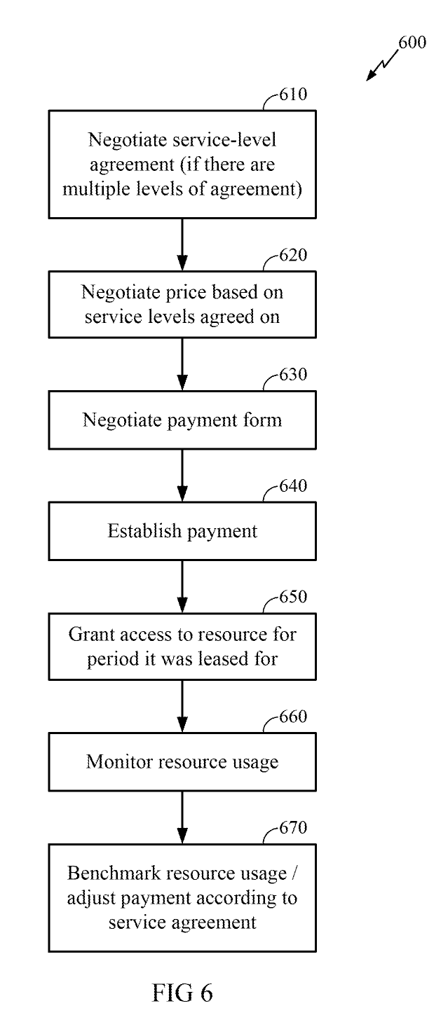

In an exemplary embodiment, based on the service level parameters established at block 330, a service level agreement (SLA) (or “service agreement”) may be formed between an owner terminal and the user terminal, e.g., according to the procedures as later described with reference to FIGS. 5 and 6. An SLA may specify the particular service level parameters according to which a resource will be provided to the user terminal, and may specify, e.g., the types of resource to be offered, the amounts of the resources, guaranteed latency, etc. In an exemplary embodiment, the SLA may also specify a particular time schedule according to which the resource will be offered. In an alternative exemplary embodiment, the SLA need not specify the particular time schedule according to which the resource will be offered, and such time schedule may be specified outside the scope of the SLA.

At block 340, the lease broker 212 establishes price levels corresponding to the service levels offered. For example, the lease broker 212 may request monetary compensation for use of its available network traffic bandwidth, with the price based on, e.g., per-kbps usage, etc.

At block 350, the lease broker 212 may advertise the availability of its local resource 216 over the network 110. The information may be sent, e.g., via broadcast or unicast to its peers on the network 110. Alternatively or in conjunction, the lease broker 212 may respond to a request for capability message received from a user broker 222.

At block 360, the lease broker 212 waits to receive bids from user terminals.

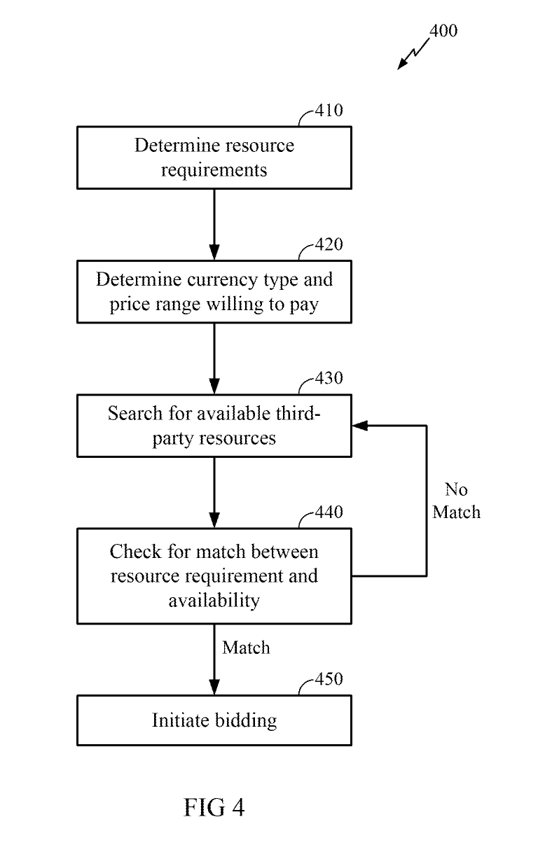

FIG. 4 illustrates an exemplary embodiment 400 of a procedure performed by the user broker 222 at the user terminal 220 shown in FIG. 2. Note FIG. 4 is shown for illustrative purposes only, and is not meant to limit the scope of the present disclosure to any particular procedure shown.

In FIG. 4, at block 410, the user broker 222 determines the resource requirements of the user terminal 220. The resource requirements may arise from one or more applications, such as application 226, running at the user terminal 220. The resource requirements may include, e.g., additional desired network traffic bandwidth, additional computational bandwidth, additional storage capacity, etc.

At block 420, the user broker 222 determines the currency type and price range that a user of the user terminal 220 is willing to pay to lease those additional resources from another terminal. For example, the currency type may be monetary, and the user may be willing to pay, e.g., up to 5 dollars to lease the desired resources. Alternatively, the currency type need not be monetary, and the user of the user terminal 220 may be willing to offer use of its own resources in exchange for using the resources of other terminals. For example, the user terminal 220 may determine that it has excess storage capacity, and may offer a certain number of megabytes of its local storage capacity for use by another terminal in exchange for additional network traffic bandwidth.

Alternatively, service level agreements (SLA's) between an owner terminal and a user terminal may be traded as currency, and different values may be assigned to service level agreements for the same resource. In an exemplary embodiment, a user terminal may own a first SLA to use a particular resource according to a first time schedule. The user terminal may exchange the first SLA for a second SLA for use of the same resource according to a second time schedule. Use of the resource during the second time schedule may be more valuable than use of the resource during the first time schedule. Accordingly, to exchange the first SLA for the second SLA, the user terminal may be required to offer additional payment, in view of the fact that the second SLA is more valuable than the first SLA. Alternatively, if the first SLA is more valuable than the second SLA, then the user terminal may instead be offered payment for exchanging the first SLA for the second SLA. Such alternative exemplary embodiments are contemplated to be within the scope of the present disclosure.

It will be appreciated that the currency type/price range/compensation offered by the user broker 222 need not be as explicitly enumerated herein, and may be any type of reward. Such alternative exemplary embodiments are contemplated to be within the scope of the present disclosure.

At block 430, the user broker 222 may search for available resources as advertised by other terminals on the network 110. For example, the user broker 222 may obtain the information broadcast or unicast by the lease broker 212 at block 350 of FIG. 3.

At block 440, the user broker 222 may check for a match between the resource requirements of the user terminal 210 and the available resources of an owner terminal 210 as advertised by the owner terminal's lease broker 212. If there is no match, the user broker 222 may return to block 430 and continue searching. If a match is obtained, the user broker 222 may proceed to block 450.

At block 450, the user broker 222 may initiate bidding for the resource.

Note the procedure performed by the user broker 222 in FIG. 4 is shown for illustrative purposes only, and is not meant to limit the scope of the present disclosure. In an alternative exemplary embodiment, the user broker 222 need not determine the currency type and price range it is willing to pay at block 420. Rather, the user broker 222 may wait to receive information from the lease broker 212 regarding the price at which a particular resource is being offered. Thereafter, the user broker 222 may prompt a user (not shown) of the user terminal with the offered price, and wait for user acceptance. Such alternative exemplary embodiments are contemplated to be within the scope of the present disclosure.

FIG. 5 illustrates an exemplary embodiment 500 of an interaction between the lease broker 212 and the user broker 222 during the bidding process.

In FIG. 5, at block 510A, the lease broker 212 waits for a bid from a user terminal to use the local resources 216 at the owner terminal 210. Block 510A may correspond, e.g., to block 360 described with reference to FIG. 3. At block 510B, the user broker 222 initiates bidding by submitting a bid to the lease broker 212.

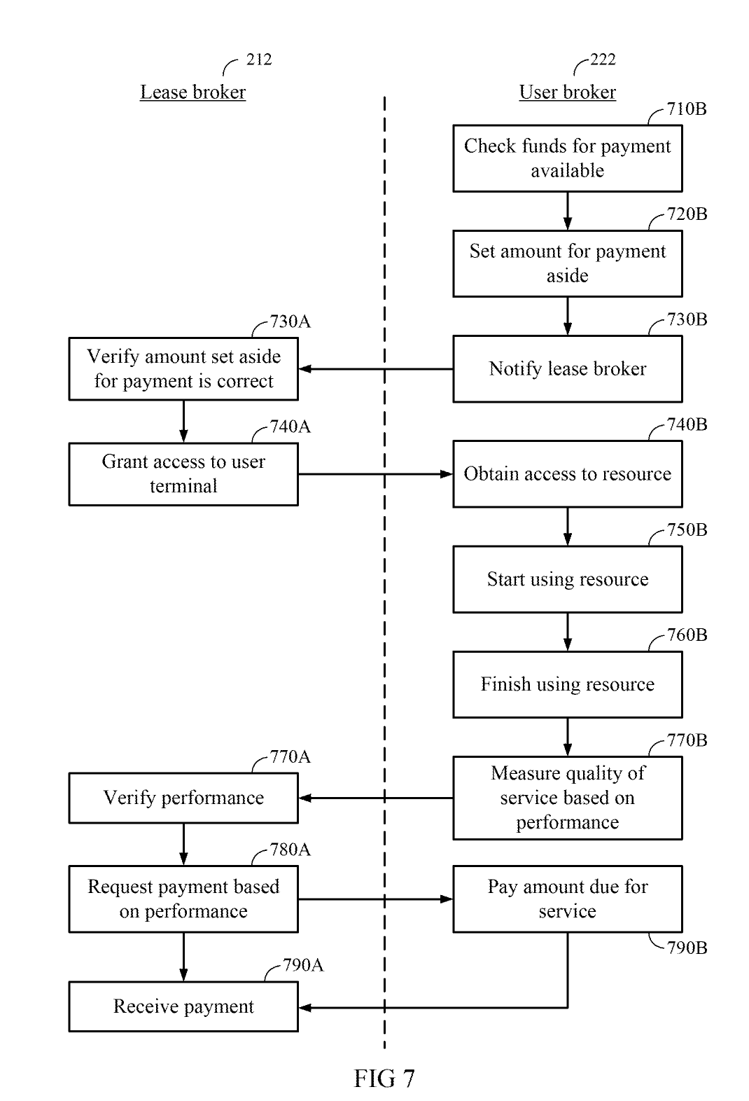

Thereafter, at blocks 520A and 520B, the lease broker 212 and user broker 222 enter negotiation, and try to reach an agreement as to the price and other terms at which the local resource 216 will be leased to the user terminal 220. In an exemplary embodiment, blocks 520A and 520B may include several exchanges of offers, counter-offers, etc., as in a typical negotiation between two parties. Further description of specific operations that may be performed at blocks 520A and 520B is given below with reference to FIGS. 6 and 7.

Following blocks 520A and 520B, the owner terminal 210 begins to share its resource with the user terminal 220 at block 530A. Likewise, at block 530B, the user terminal 220 begins to use the resource provided by the owner terminal 210.

FIG. 6 illustrates an exemplary embodiment 600 of specific operations that may be performed by a lease broker 212 during the bid negotiation blocks 520A and 520B and the resource usage blocks 530A and 530B shown in FIG. 5. Note FIG. 6 is shown for illustrative purposes only, and is not meant to limit the scope of the present disclosure to any particular operations to be performed during bid negotiation or resource usage.

At block 610, a service-level agreement (SLA) is negotiated between the lease broker 212 and the user broker 222. As earlier described, the service level agreement may specify parameters such as minimum resource bandwidth guaranteed to be provided by the lease broker 212, latency guarantees, etc. Note for a single resource, different service level agreements may be offered according to different time schedules for use of that resource.

At block 620, a price for the agreed-upon service level is negotiated between the lease broker 212 and the user broker 222.

At block 630, the form of payment is negotiated. For example, if the payment is monetary, then credit card payment or bank account transfer details may be specified. Alternatively, if payment is in the form of other resources, the service levels of the payment resources may also be specified.

At block 640, the lease broker 212 verifies that payment has been made by the user broker 222.

At block 650, the lease broker 212 grants access to the local resource 216 according to the service level as agreed upon at block 610.

At block 660, the lease broker 212 monitors the usage of its local resource 216 by the user terminal 216. As shown in FIG. 2, the lease broker 212 may monitor whether the usage of the resource 216 exceeds an agreed-upon service level.

At block 670, the lease broker 212 may benchmark the actual amount of resources used by the user terminal 216. The lease broker 212 may adjust the payment required from the user terminal 216 in response to actual usage.

FIG. 7 illustrates an alternative exemplary embodiment of a scheme for establishing a payment agreement that may be performed by the lease broker 212 and the user broker 222 to lease the resources 216 of the owner terminal 210.

At block 710B, the user broker 222 may check to make sure that it has sufficient funds available to lease the resources.

At block 720B, the user broker 222 may set aside funds for such payment, without actually paying the lease broker 212.

At block 730B, the user broker 222 may notify the lease broker 212 that the funds have been set aside.

At block 730A, the lease broker 212 may verify that the amount set aside for payment by the user broker 222 is correct.

At block 740A, the lease broker 212 may grant access to the resource 216 by the user terminal 220 in response to the verifying performed at block 730A.

At block 740B, the user terminal 220 may obtain access to the resource 216.

At block 750B, the user terminal 220 may start to use the resource 216.

At block 760B, the user terminal 220 finishes using the resource 216.

At block 770B, the user broker 222 may measure the quality of service based on the actual resource usage. This may be used to determine the actual payment due to the lease broker 212.

At block 770A, the lease broker 212 may also verify the performance, and request payment for the actual resource usage at block 780A.

At block 790B, the user broker 222 pays the amount owed for the actual resource usage.

At block 790A, the lease broker 790B receives payment.

While FIG. 7 illustrates at block 790B that payment is made after the service is performed, it will be appreciated that the scheme shown in FIG. 7 may readily be modified to accommodate, e.g., payment prior to the service being performed. Such alternative exemplary embodiments are contemplated to be within the scope of the present disclosure.

It will be appreciated that a single terminal may adopt the techniques described herein to simultaneously act as both an owner terminal for certain resources and as a user terminal for other resources, subject to the available communications bandwidth between the single terminal and the network 110. For example, a first terminal may lease a storage medium from a second terminal on the network, while simultaneously the first terminal's network bandwidth may be leased to a third terminal on the network. Furthermore, a single terminal may lease resources from multiple owner terminals simultaneously, and likewise, may also lease resources to multiple user terminals simultaneously. Such exemplary embodiments are contemplated to be within the scope of the present disclosure.

It will be further appreciated that various modifications to the techniques described above may be readily derived by one of ordinary skill in the art within the scope of the present disclosure. For example, in an alternative exemplary embodiment (not shown), an SLA and corresponding compensation terms may be dynamically modified after bidding and negotiation for a resource has taken place. Such modification may be initiated by either the owner terminal or the user terminal. For example, if an owner terminal determines that it can no longer provide access to a given level of bandwidth or storage, etc., e.g., due to increased local demand for the resource, then the owner terminal may alert the user terminal that it desires to modify the negotiated SLA. Modification of the SLA may include adjustment of the payment due, and/or include refund of payment already made by the user terminal. Modification of the SLA may also specify new terms according to which the resource may be offered. As a further example, if a user terminal determines that it no longer needs to use the resource of the owner terminal, it may request a modification of the SLA with the owner terminal to reflect the reduced need. In an exemplary embodiment, such modification of the SLA may be subject to, e.g., any conditions on modifying the SLA as originally agreed upon by the parties.

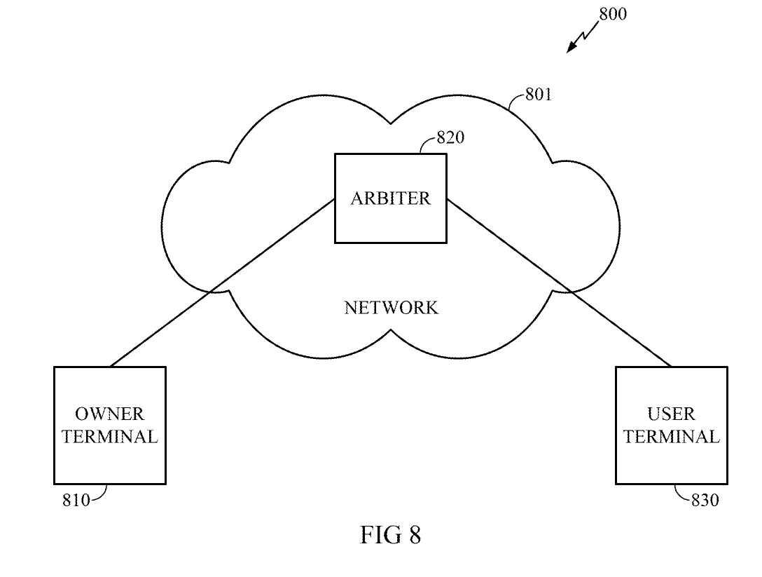

FIG. 8 illustrates an exemplary embodiment 800 of a system wherein an arbiter 820 is provided. The arbiter 820 may be an independent terminal from the owner terminal 810 and the user terminal 820, and may monitor whether or not the service level agreed upon is being maintained. The arbiter 820 may also be responsible for benchmarking the actual service offered and adjusting the payment accordingly. The arbiter 820 may further keep track of historical data of the service usage for later reference. In an exemplary embodiment, the arbiter may be a third-party entity that oversees transactions conducted between an owner terminal and a user terminal. The arbiter may act, e.g., as a broker in settling payment based on the service level delivered compared to the service level offered.

Further described hereinbelow are specific applications of the techniques of the present disclosure. Note the applications are given for illustrative purposes only, and is not meant to limit the scope of the present disclosure in any way.

A. Virtual Data Center

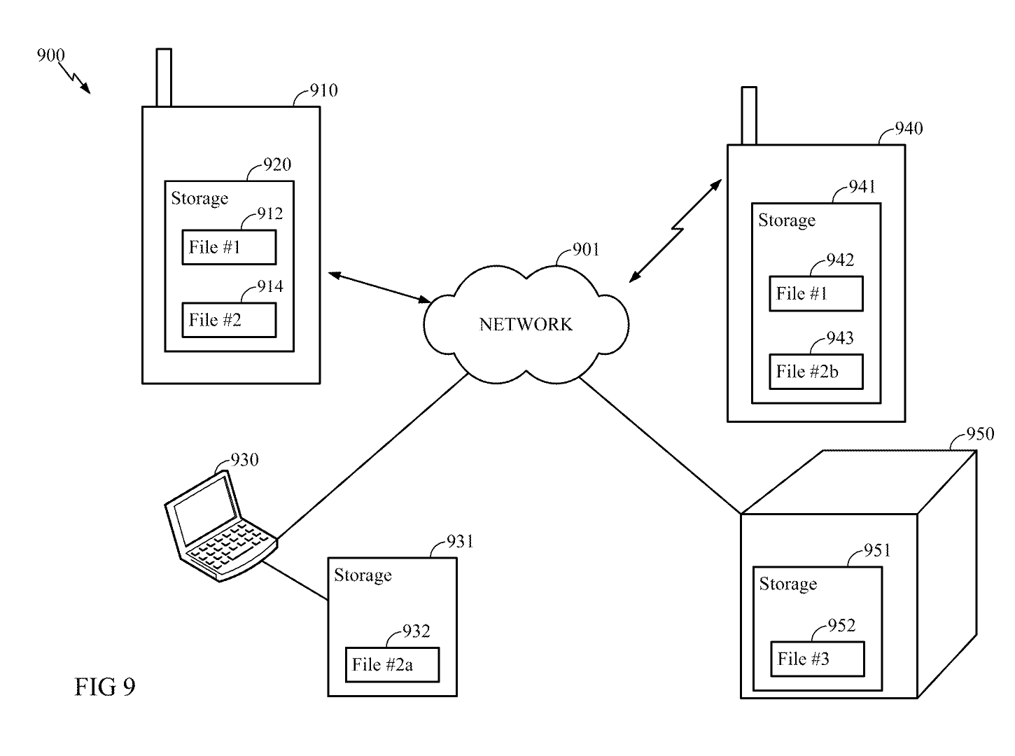

FIG. 9 illustrates an exemplary embodiment 900 of a virtual data center according to the present disclosure. In FIG. 9, a first device 910 may store and retrieve File #1 912 and File #2 914 on a local storage medium 920 located in the first device 910. Also in communication with the first device 910 over the network 901 are devices 930, 940, and 950. Through the resource advertisement, bidding, and resource usage techniques earlier described hereinabove, the first device 910 may arrange to lease storage space in the devices 930, 940, and 950 for local use at the first device 910.

In a first exemplary embodiment of a virtual data center, a user terminal may store and access one or more of its files on one or more owner terminals accessible over the network. For example, the first device 910 may store a File #3 952 on storage medium 951 of device 950, wherein File #3 is not locally stored on the storage medium 920 of device 910. The user terminal may do so for any number of reasons, e.g., it does not have the capacity to locally store the file, or it may be more cost-effective to store the file remotely, etc.

In a second exemplary embodiment of a virtual data center, a user terminal may store back-up versions of its files on one or more owner terminals from which the user terminals leases storage space. For example, the first device 910 may access a backed-up version of its local File #1 912 as File #1 942 on storage medium 941 of device 940.

In an exemplary embodiment (not shown), back-up copies of one or more files belonging to the first device 910 may further be replicated and separately stored on multiple owner terminals throughout the network. This may advantageously increase the probability that the first device 910 will be able to access its back-up file at any time. For example, if one or more owner terminals storing the back-up file of the first device 910 is not available to the first device 910 at the moment, then the first device 910 may instead access its back-up file from any of the other owner terminals storing its back-up file.

In a third exemplary embodiment, a single file belonging to a user terminal may be disassembled into individual sub-files, and separately stored on different owner terminals. For example, in FIG. 9, the first device 910 may back up a portion File #2a 932 of File #2 914 on the storage medium 931 of device 930, and another portion File #2b 943 on the storage medium 941 of device 940. In an exemplary embodiment, the disassembly may be performed by the user terminal, or it may be performed by a separate entity coupled to the user terminal, e.g., directly, or over the network.

In an exemplary embodiment, any aspects of the virtual data center separately described above may be provided in combination in a single system. Such exemplary embodiments are contemplated to be within the scope of the present disclosure.

It will be appreciated from the above description of the virtual data center that, once an agreement concerning lease of a resource is in place, the actual location of the file on the network 901 need not be known to the user terminal.

In an exemplary embodiment, the compensation to devices 930, 940, and 950 for usage of their respective storage space may include monetary compensation charged as a function of the amount of storage space leased, and/or the amount of time for which the storage space is leased. In an exemplary embodiment, the network 901 may be the Internet. The first device 910 may be, e.g., a mobile phone having limited local storage resources, while the devices 930, 940, and 950 may be personal computers or other equipment having available storage resources. Note the leasing devices may generally include any device with available storage space that is connected to the network, and also supports a platform for leasing its resources according to the techniques of the present disclosure.

B. Mobile phone bandwidth leasing

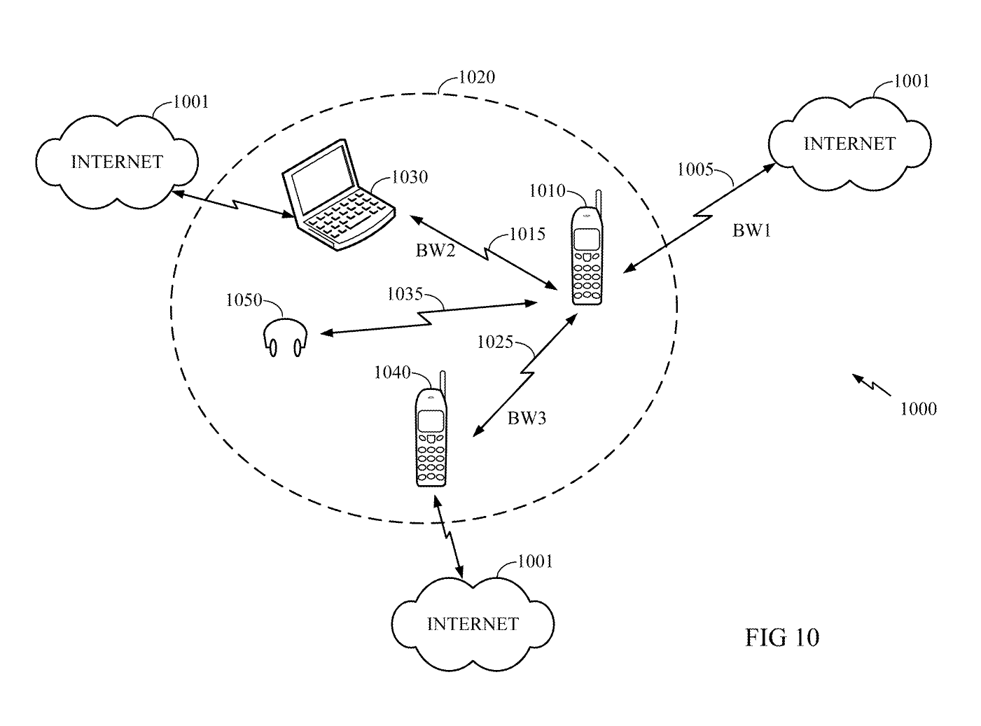

FIG. 10 illustrates an exemplary embodiment 1000 of a network traffic bandwidth leasing scheme according to the present disclosure. In FIG. 10, a mobile phone 1010 establishes a first connection 1005 with the Internet 1001. In an exemplary embodiment, the mobile phone 1010 may utilize a wireless data connection such as, e.g., W-CDMA, cdma2000, or any other wireless communications protocols known in the art. The first connection 1005 may support a maximum data transfer rate BW1. To transfer data transfer rates in excess of BW1, the mobile phone 1010 may lease network traffic bandwidth from other terminals.

For example, the mobile phone 1010 may also have access to a Bluetooth network 1020, and communicate with other devices 1030, 1040, 1050 over connections 1015, 1025, 1035 using the Bluetooth protocol. Via the techniques of the present disclosure, the mobile phone 1010 may discover that devices 1030 and 1040 are leasing Internet traffic bandwidth on a per-kilobyte basis. After successfully bidding for the bandwidth, the mobile phone 1010 additionally utilizes the second connection 1015 and third connection 1025 at rates of BW2 and BW3, respectively, to access the Internet.

In an exemplary embodiment, the devices 1030, 1040 may be other mobile phones accessing the data network using W-CDMA, cdma2000, or another wireless communications protocol. Alternatively, any or all of the devices 1030, 1040 may be, e.g., a personal computer accessing the Internet via an Ethernet connection.

C. Dynamic Distributed Computing

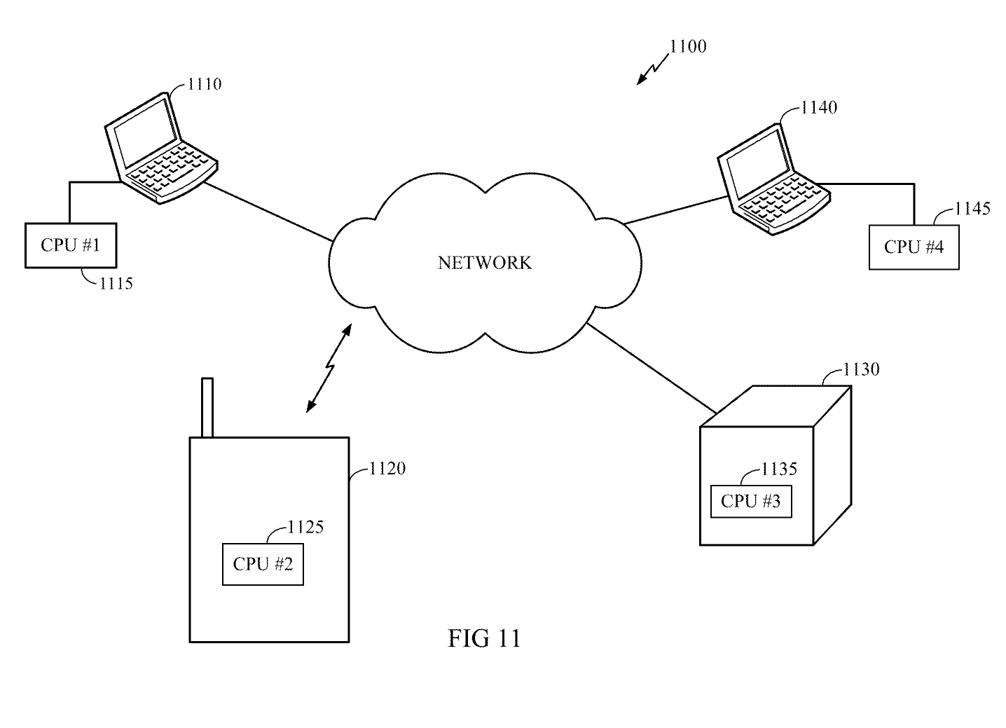

FIG. 11 illustrates an exemplary embodiment 1100 of a distributed computing scheme according to the present disclosure. In FIG. 11, a main computing terminal 1110 is charged with carrying out a computing task. The computing task may require a large computational bandwidth that may exceed the resources of the local CPU 1115 of the main computing terminal 1110. The main computing terminal 1110 may thus search for other terminals connected to the network 1101 that may be advertising their computational resources for lease. In FIG. 11, a mobile phone 1120, a mainframe computer 1130, and another personal computer 1140 have available computational resources CPU2 1125, CPU3 1135, and CPU4 1145 for lease. After determining the available computational bandwidth, and successfully bidding for the resources, the main computing terminal 1110 may distribute the computational tasks to the various terminals 1120, 1130, and 1140.

In an exemplary embodiment, the make-up of the leasing terminals may change over time. For example, the mobile phone 1120 may leave the network 1101, while another mobile phone (not shown) with available computational resources may enter the network 1101. In this case, the main computing terminal 1110 may terminate its lease with the mobile phone 1120, and establish a new lease for the CPU of the newly present mobile phone. In this manner, the leasing techniques of the present disclosure allow the computing task of the main computing terminal 1110 to be dynamically distributed over multiple terminals as computational resources become available.

In an exemplary embodiment, a user terminal may further lease disk storage space and Internet bandwidth access from a plurality of owner terminals, in addition to computational resources. This may enable a multi-functional application wherein, e.g., a user terminal may direct owner terminals to download selected data from the Internet, analyze the downloaded data, store the analysis results, and provide an analysis report to the user terminal. Such exemplary embodiments wherein multiple resources are simultaneously leased and utilized are contemplated to be within the scope of the present disclosure.

D. Operating System or Application Leasing

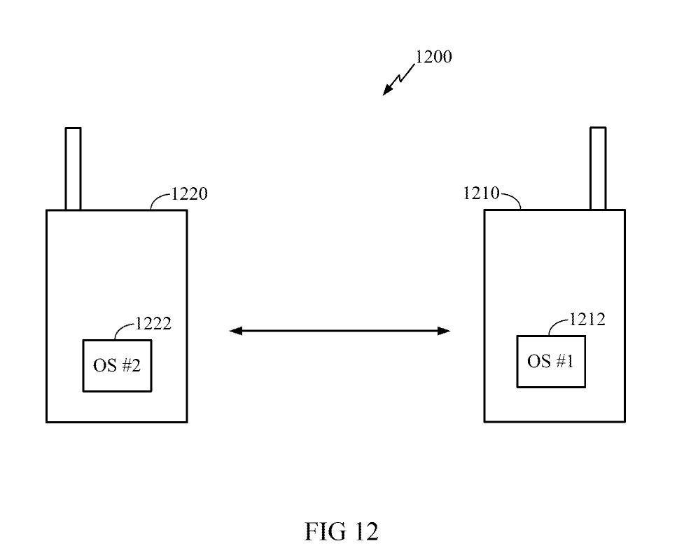

FIG. 12 illustrates an exemplary embodiment 1200 of an application/OS leasing scheme according to the present disclosure. In FIG. 12, a first mobile phone 1210 runs applications on a first operating system (OS) 1212, e.g., an Android OS for a mobile phone developed by Google Inc. A second mobile phone 1220 runs applications on a second OS 1222, e.g., an iPhone OS or “OS X” for an iPhone developed by Apple Inc.

There may arise situations wherein the first mobile phone 1210 is called upon to run a target application that is not supported by its native OS 1212. In this case, the first mobile phone 1210 may search for another terminal running an OS that does support the target application, e.g., the second mobile phone 1220. Note for simplicity, the connections to the network being the first mobile phone 1210 and second mobile phone 1220 has been omitted in FIG. 12.

According to the techniques of the present disclosure, the first mobile phone 1210 may lease the use of the second mobile phone 1220's OS 1222 to run the target application and retrieve the results of the executed target application from the second mobile phone 1220, according to the techniques of the present disclosure. For example, if the second mobile phone 1220 does not have the target application locally available, the second mobile phone 1220 may download the application from the first mobile phone 1210, or request the first mobile phone 1220 to indicate a location where the target application may be downloaded from. The second mobile phone 1220 may run the target application using the resources of the second mobile phone 1220, and provide the results of running the application to the first mobile phone 1210. The second mobile phone 1220 may perform such service for the first mobile phone 1210 according to a service level agreement specifying, e.g., the storage, bandwidth and/or CPU requirements, according to the techniques of the present disclosure.

In an alternative exemplary embodiment, if the second mobile phone 1220 already has the target application locally available, then the first mobile phone 1210 may simply request the second mobile phone 1220 to run the application. In this case, it will be appreciated that the application module on the second mobile phone 1220 may serve as a remote interface to the first mobile phone 1210 for accessing the target application on the second phone.

In an exemplary embodiment, the application on the remote device, e.g., the second phone, may expose its application programming interface (API) to other devices on the network, and thereby allow the first phone's application to directly utilize the second phone's application from over the network. In an alternative exemplary embodiment, an intermediary application may be developed, e.g., by a third party, that provides an interface to the second phone's application to allow access to it over the network by, e.g., the first phone's application. One of ordinary skill in the art will appreciate that the communication interface between a local application and a remote application may be based on, e.g., Simple Object Access Protocol (SOAP), Remote Procedure Protocol (RPC), Adobe Flex, or any other standard protocol known in the art.

In an exemplary embodiment, if the first mobile phone 1210 needs to perform a web search, the first mobile phone 1210 may locally perform a search by accessing a first search website, while simultaneously offloading a search accessing a second search website to the second mobile phone 1220. After the search is completed, the second mobile phone 1220 may return the search results to the first mobile phone 1210. It will be appreciated that the results from both searches will be more extensive than the single search conducted by the first mobile phone 1210 using its own resources.

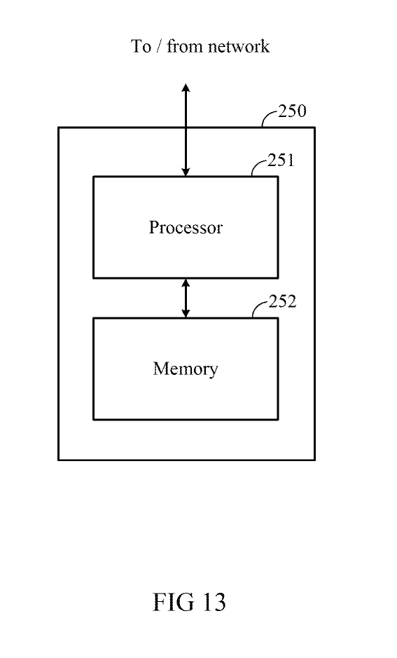

FIG. 13 illustrates an exemplary embodiment of an apparatus 250 for implementing either the owner terminal 210 or user terminal 220 described in FIG. 2. Note the apparatus is shown for illustrative purposes only, and is not meant to limit the scope of the present disclosure to any particular exemplary embodiments shown.

In FIG. 13, a processor 251 is shown coupled to a memory 252. In the exemplary embodiment wherein the apparatus 250 is configured as a user terminal 220, the memory 252 may store instructions for causing the processor 251 to implement an application module configured to run an application and a user broker module. The user broker module may be configured to determine a requirement set of the application module; identify at least one remote terminal having a resource to at least partially satisfy the requirement set of the application module; enable the application module to use the resource of the at least one remote terminal according to a service agreement; and arrange for the at least one remote terminal to be compensated based on the use of the resource.

In the exemplary embodiment wherein the apparatus 250 is configured as an owner terminal 210, the memory 252 may store storing instructions for causing the processor 251 to implement a lease broker module configured to: determine terms on which a resource is available to be used by at least one remote terminal; advertise the terms to the at least one remote terminal; negotiate a service agreement with the at least one remote terminal to use the resource; enable the at least one remote terminal to use the resource; and arrange to be compensated by the at least one remote terminal based on the use of the resource.

One of ordinary skill in the art will appreciate that for simplicity, various elements have been omitted from the implementation illustrated in FIG. 13, e.g., supporting electrical circuitry and/or power supplies, communications transceivers for allowing the apparatus to communicate with a network, etc. The provision of such elements is readily derivable by one of ordinary skill in the art in light of the present disclosure.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other exemplary embodiments without departing from the spirit or scope of the invention. Thus, the present invention is not intended to be limited to the exemplary embodiments shown herein but is to be accorded the widest scope consistent with the principles and novel features disclosed herein.

1. An apparatus comprising:
a processor; and
at least one memory coupled to the processor, the at least one memory storing instructions for causing the processor to implement an application module configured to run an application and a user broker module configured to:
determine a requirement set of the application module;
identify at least one remote terminal having a resource to at least partially satisfy the requirement set of the application module;
enable the application module to use the resource of the at least one remote terminal according to a service agreement; and
arrange for the at least one remote terminal to be compensated based on the use of the resource.

2. The apparatus of claim 1, the user broker module configured to identify the at least one remote terminal by receiving an advertised resource capability of the at least one remote terminal, and by determining if the advertised resource capability at least partially satisfies the requirement set of the at least one remote terminal.

3. The apparatus of claim 1, the requirement set of the application module comprising a required amount of data storage capacity.

4. The apparatus of claim 1, the requirement set of the application module comprising a required amount of computational bandwidth.

5. The apparatus of claim 1, the requirement set of the application module comprising a required amount of network traffic bandwidth.

6. The apparatus of claim 1, the requirement set of the application module comprising a time schedule according to which the resource may be used.

7. The apparatus of claim 1, the requirement set of the application module comprising at least one parameter selected from the group consisting of a supported target application, availability of specialized hardware, and a supported operating system.

8. The apparatus of claim 1, the user broker module configured to arrange for the at least one remote terminal to be compensated by paying the at least one terminal using monetary currency.

9. The apparatus of claim 1, the service agreement specifying at least one parameter selected from the group consisting of: a minimum amount of guaranteed data storage capacity, a minimum amount of computational bandwidth, a minimum amount of network traffic bandwidth, and a supported operating system.

10. The apparatus of claim 1, the service agreement specifying a time schedule according to which the resource of the at least one remote terminal may be used.

11. The apparatus of claim 1, the apparatus comprising a mobile phone, the application comprising a web browser, the requirement set comprising a minimum bandwidth for accessing the Internet.

12. The apparatus of claim 1, the application configured to process a computational task, the requirement set comprising a minimum computation bandwidth for processing at least a portion of the computational task.

13. The apparatus of claim 1, the apparatus comprising a first hardware for running a first operating system (OS), the requirement set comprising running a target application for a second OS, the at least one remote terminal comprising a second hardware for running the second OS, the user broker module configured to enable the application module to use the resource of the at least one remote terminal by running the target application on the second OS using the second hardware.

14. The apparatus of claim 1, the user broker module configured to identify the at least one remote terminal by communicating with a lease broker module of the at least one remote terminal using a wireless communications link.

15. The apparatus of claim 1, the user broker module configured to identify the at least one remote terminal by communicating with a lease broker module of the at least one remote terminal using a wired communications link.

16. An apparatus comprising:
a processor; and
at least one memory coupled to the processor, the at least one memory storing instructions for causing the processor to implement a lease broker module configured to:
determine terms on which a resource is available to be used by at least one remote terminal;
advertise the terms to the at least one remote terminal;
negotiate a service agreement with the at least one remote terminal to use the resource;
enable the at least one remote terminal to use the resource; and
arrange to be compensated by the at least one remote terminal based on the use of the resource.

17. The apparatus of claim 16, the resource comprising data storage capacity.

18. The apparatus of claim 16, the resource comprising computational bandwidth.

19. The apparatus of claim 16, the resource comprising network traffic bandwidth.

20. The apparatus of claim 16, the resource comprising a resource selected from the groups consisting of: a supported target application, a specialized hardware module, and a supported operating system.

21. The apparatus of claim 16, the lease broker module configured to arrange to be compensated by receiving monetary currency from the at least one remote terminal.

22. The apparatus of claim 16, the service agreement specifying a selected from the group consisting of: a minimum amount of guaranteed data storage capacity, a minimum amount of computational bandwidth, and a minimum amount of network traffic bandwidth.

23. The apparatus of claim 16, the service agreement specifying a time schedule according to which the resource may be used.

24. The apparatus of claim 16, the service agreement specifying a parameter from the group consisting of: a supported target application, a specialized hardware module, and a supported operating system.

25. The apparatus of claim 16, the apparatus comprising a mobile phone, the at least one remote terminal comprising a mobile phone, the service agreement comprising a minimum bandwidth for accessing the Internet.

26. The apparatus of claim 16, the apparatus comprising a first hardware for running a first operating system (OS), the service agreement comprising running a target application for the first OS, the lease broker module configured to enable the at least one remote terminal to use the resource by running the target application on the first OS using the first hardware.

27. The apparatus of claim 16, the lease broker module configured to advertise by communicating with a user broker module of the at least one remote terminal using a wireless communications link.

28. The apparatus of claim 16, the lease broker module configured to advertise by communicating with a user broker module of the at least one remote terminal using a wired communications link.

29. The apparatus of claim 16, the resource being a resource locally available on the apparatus.

30. The apparatus of claim 16, the resource being remotely located from the apparatus.

31. A method comprising:
determining a requirement set of an application module;
identifying at least one remote terminal having a resource to at least partially satisfy the requirement set of the application module;
enabling the application module to use the resource of the at least one remote terminal according to a service agreement; and
arranging for the at least one remote terminal to be compensated based on the use of the resource.

32. The method of claim 31, the arranging comprising paying the at least one remote terminal using monetary currency.

33. The method of claim 31, the requirement set comprising at least one parameter selected from the group consisting of: a required amount of data storage capacity, a required amount of computational bandwidth, a required amount of network traffic bandwidth, a time schedule according to which the resource may be used, a supported target application, availability of specialized hardware, and a supported operating system.

34. The method of claim 31, the identifying at least one remote terminal comprising communicating with a lease broker module of the at least one remote terminal.

35. A method comprising:
determining terms on which a resource is available to be used by at least one remote terminal;
advertising the terms to the at least one remote terminal;
negotiating a service agreement with the at least one remote terminal to use the resource;
enabling the at least one remote terminal to use the resource; and
arranging to be compensated by the at least one remote terminal based on the use of the resource.

36. The method of claim 35, the advertising comprising sending the terms to the at least one remote terminal in response to receiving a request for capability message.

37. The method of claim 35, the resource comprising at least one member selected from the group consisting of: data storage capacity, computational bandwidth, network traffic bandwidth, a supported application, availability of specialized hardware, and a supported operating system.

38. The method of claim 35, the negotiating comprising communicating with a user broker module on the at least one remote terminal.

39. An apparatus comprising:
means for determining a requirement set of an application module;
means for identifying at least one remote terminal having a resource to at least partially satisfy the requirement set of the application module;
means for enabling the application module to use the resource of the at least one remote terminal according to a service agreement; and
means for arranging for the at least one remote terminal to be compensated based on the use of the resource.

40. An apparatus comprising:
means for determining terms on which a resource is available to be used by at least one remote terminal;
means for advertising the terms to the at least one remote terminal;
means for negotiating a service agreement with the at least one remote terminal to use the resource;
means for enabling the at least one remote terminal to use the resource; and
means for arranging to be compensated by the at least one remote terminal based on the use of the resource.
